(19) United States
(12) Patent Application Publication
(10) Pub. No.: US 2014/0380418 A1
(43) Pub. Date: Dec. 25, 2014

(54) System and method for verifying the legitimacy of requests sent from clients to server

(71) Applicant: Haoxu Wang, Halifax (CA)

(72) Inventor: Haoxu Wang, Halifax (CA)

(21) Appl. No.: 14/019,063

(22) Filed: Sep. 5, 2013

Related U.S. Application Data
(60) Provisional application No. 61/836,767, filed on Jun. 19, 2013.

(51) Int. Cl. H04L 29/06

(52) U.S. Cl. CPC H04L 63/08
USPC 726/3

(57) ABSTRACT

Disclosed herein are method and system that can be used for: preventing brute force attacks against passwords; preventing denial of service attacks by flooding; restricting bots from spamming emails, registering resources, and collecting sensitive information; and possibly in other challenge-response tests. It also can be used to replace CAPTCHA in some situations, with advantages of better reliability and spares human participation during the process. This present invention considers a request as legitimate when the requesting client has paid certain amount of computation resource required by the server, in exchange for the server to admit the request. It performs a challenge-response test. The subject challenged is the sincerity of the client to make that request, which is measured by computation resources the client willing to spend in exchange for the service provided by the server. The invention also gives a method to control and guarantee the computation complexity of the challenge problem of the test.

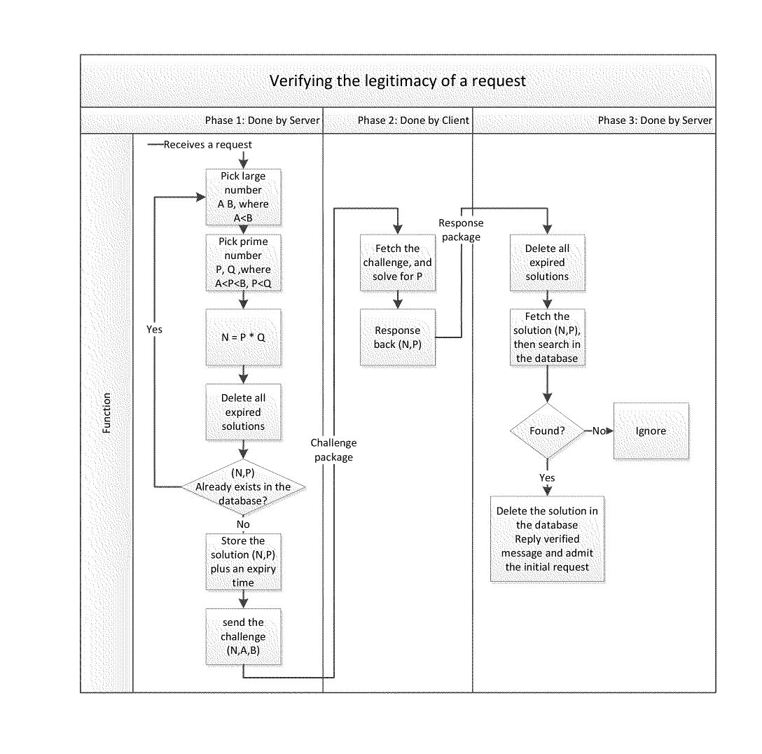

### BACKGROUND OF THE INVENTION

The present invention relates to network security.

Sending mass of batch-generated requests over short time can be used towards various malicious purposes. For example, brute force attack against secret key; denial of service attack by flooding; internet bots spamming.

Some techniques were used to separate a legitimate request from a malicious one by attempting to distinguish requests sent from human users and others automatically generated by computers. An example application of this method is CAPTCHA. Two of the major drawbacks are: 1. Reliability is not guaranteed with the improving optical character recognition (OCR) techniques; 2. Human users are also punished in the process, forced into identifying and inputting verification code.

Hence, there is a need for a method to effectively distinguish legitimate and malicious request, meanwhile, without the two drawbacks mentioned above.

### BRIEF SUMMARY OF THE INVENTION

This present invention can be used for: preventing brute force attacks against passwords; preventing denial of service attacks by flooding; restricting bots from spamming emails, registering resources, and collecting sensitive information; and possibly in other challenge-response tests. It also can be used to replace CAPTCHA, with advantages of better reliability and sparing human participation during the process.

The present invention considers a request legitimate when the requesting client has paid certain amount of computation resource, in exchange for the server to admit the request. It performs a type of challenge-response test. The subject challenged is the sincerity of the client to make that request, which is measured by computation resources the client willing to trade for the service offered by the server. Applications of this system limits the number of requests a client can send in a certain time period, by forcing the client to pay certain amount of computation before admitting the received request. In specific, the length of computation time is guaranteed by challenging the client computer to solve a known NP problem (particularly, the prime factorization of a large composite number composed by two large prime factors). The computation time required (relative to mainstream processors in the present market) is proportional to the complexity of the prime factorization problem, which can be controlled by providing the range of the smaller prime factor.

### BRIEF DESCRIPTION OF THE DRAWING

The drawing is a workflow chart for phase 1-3 of the challenge-response test, which described in the Detailed Description of the Invention section.

### DETAILED DESCRIPTION OF THE INVENTION

The present invention considers a request legitimate when the requesting client has paid certain amount of computation resource, in exchange for the server to admit the request. It verifies the legitimacy of requests made by clients based on challenge-response tests.

The following content describe how an application of the invention (the server in the scenario) verifies the legitimacy of a request. As a character of this system, the server limits the number of legitimate requests a client can make in a certain time period.

The system is deployed to be capable of:

1. Generate a large prime number in a certain range, using any known prime number generating algorithms.

2. Perform basic operations on large numbers: multiplications, subtractions, additions, comparisons, etc.

3. Maintain a database which stores all solutions along with their expiry time of all recent sent challenges.

Note: In the following notation, uppercase letters with underline denote variable names of positive integers.

Phase 1

When the server receives a request, phase 1 begins.

In this phase, the server sends back a challenge to the client, in plaintext. The challenge consists of three large numbers chosen by the server: (N, A, B). To complete phase 1, the server does the following six steps:

1. The server picks a pair of random numbers A and B, where A and B are two large positive integers with A<B.

2. The server generate two random large prime number Q and P, where P<Q and P is in the range from A to B.

3. The server calculate N=P*Q, to get a challenge number set (N, A, B) and corresponding solution number set (N, P).

4. The server searches in the database and deletes all expired solutions of challenges in the database.

5. Search for the solution. If the newly generated solution is already in the database, restart from step 1. If not, store the solution along with an expiry time assigned to it in the database.

6. The server sends the challenge to the client.

Phase 2

When the client receives the challenge, phase 2 begins.

In this phase, the client sends the corresponding response to the server, in plaintext.

The response consists of two numbers computed by the client: (N, P). To complete phase 2, the client processed by the following two steps:

1. The client fetches the challenge, and solves for the unique solution P (the smaller prime number of the two prime factors of N) in the range from A to B. Again the complexity is in O(B−A).

2. The client responds back to the server with solution set (N, P).

Phase 3

When the server receives the response, phase 3 begins.

In this phase, the server verifies the legitimacy of the client's initial request based on the response. Then inform the arbitration to the client. To complete phase 3, the server processed by the following three steps:

1. The server searches and deletes all expired solutions of challenges in the database.

2. The server fetches the solution pair (N, P) in the response, and searches it in the database.

3. If found, the server first deletes the solution in database, then replies the client with verified message and admits the initial request. If not found, it ignores the request.

Choices of number

Choices of number affect the behavior and performance of this challenge-response test:

1. Number A and B have to be large enough to insure P is large enough. A large value of P insures building a pre-compute table for all possible (N P and Q) set is infeasible, and prevent possible attack introduced in part 4(b) of this section.

2. Since there is no known fast algorithm for prime factorization, the computation steps required to solve the challenge is tight upper bound by O(B−A). Thus, the range of average time required to solve the challenge is controllable, considering mainstream processors in the present market.

3. Setting the expiry time enable the system to regularly remove solutions for challenges that were lost or abandoned by the client, and also for security purpose of part 4.

4. Interval before solution expires has to be short enough to prevent possible attacks, for example:
(a) Flooding attack against space limit of the database.
(b) Attacker could first make many requests and fill up the database with solutions which unknown by the attacker, then send random solution (N, P) pairs try to hit one of the solutions in the database. Keeping too many solutions increase the chance of a success hit.

5. Interval before solution expires has to be long enough considering:

(a) Allow less advanced processor to solve the challenge in time. (b) Allow the system to properly work in congested network, considering some reasonable delay.

6. In phase 3, if a correct response of a challenge were received by the server, the corresponding solution will be removed from the database. Each random generated solution can only verify one request, for the purpose of preventing replay attack. This would not make the system vulnerable to denial of service, by the attacker solve and then response to complete the challenge before the user who sent the original request. Such attack could be resolved by applying the following: When the client detected such suspicious incident, which was indicated by the server ignored the client's correct response. It could resend more request in parallel (and gradually increase if necessary), then by randomly choose and solve one of the challenges received, the requests will be admitted by the server. But to denial the service, the attacker has to race to solve all challenges, which makes the attack infeasible.

Usage in other ways:

This present invention can be used in:

1. Situations where an entity A wants to determine whether a request from entity B is worth the effort or relatively safe (not likely mass batch-generated). Entity A could use this method to demand entity B to demonstrate the sincerity of the request, in measure of computation time willing to spend.

2. When an entity A wants to determine whether a request was mass generated by non-human user, or to limit the capability of internet bots from accessing computing services. For example: To restrict bots from spamming emails, registering resources, collecting sensitive information.

1. A method of challenge-response test where the subject challenged is the sincerity of the client, which measured by the computation resources the client willing to trade for the service provided by the server.

2. A method to control the complexity of a challenge-response test. That is to challenge client with a prime factorization problem of finding the prime factors of a large composite number, and then to control the complexity by providing the range of the smaller prime factor to client.

3. A system that limits the number of requests admitted from each client in a certain time period, by forcing the client to pay certain amount of computation before admitting the received request.

4. The system of claim 3, which considers a request legitimate when the requesting client has paid certain amount of computation resource in exchange for the server to admit the request.
